(19) United States
(12) Patent Application Publication
(10) Pub. No.: US 2018/0369868 A1
(43) Pub. Date: Dec. 27, 2018

(54) SCREEN

(71) Applicant: AQSEPTENCE GROUP PTY LTD, Queensland (AU)

(72) Inventors: David John LAZZARINI, Kangaroo Point (AU); Ian Robert SOLOMON, Kenmore (AU); Steven Paul COLEMAN, Windaroo (AU); Yusuf CAJEE, Tanah Merah (AU)

(73) Assignee: AQSEPTENCE GROUP PTY LTD, Queensland (AU)

(21) Appl. No.: 15/780,535

(22) PCT Filed: Dec. 14, 2016
(86) PCT No.: PCT/AU2016/051232

§ 371 Date: May 31, 2018

(30) Foreign Application Priority Data
Dec. 18, 2015 (AU) 2015905281

(51) Int. Cl. B07B 1/46; B07B 1/12; E03B 3/06

(52) U.S. Cl. CPC B07B 1/4609; B07B 1/12; B07B 1/18; B07B 2230/01; E03B 3/06

(57) ABSTRACT

A screen includes a support structure. A plurality of screening elements is arranged in spaced relationship on the support structure to define screening apertures between adjacent screening elements. Each screening element defines a screening surface, respectively. The screening surface of each of at least some of the screening elements are spaced further from the support structure than the screening surface of each of the remaining screening elements so that, on opposed sides of each screening aperture associated with the at least some of the screening elements, the screening surfaces are at different heights.

### CROSS-REFERENCE TO RELATED APPLICATIONS

The present application claims priority from Australian Provisional Patent Application No 2015905281 filed on 18 Dec. 2015, the contents of which are incorporated herein by reference in their entirety.

### TECHNICAL FIELD

This disclosure relates, generally, to a screen and, more particularly, to a screen for screening and/or classifying material.

### BACKGROUND

Screens of various configurations are used in a number of applications. In the mining industry screens are used for media recovery, ore particle classification, de-watering, or the like. Generally screens for these applications are in the form of screening panels and sieve bends.

In other applications, screens are used in purification applications such as water extraction and such screens are often circular cylindrical in configuration. Cylindrical screens are also used for particle separation and such screens are commonly known as trommel screens.

In the case of media recovery, media in the form of magnetite is introduced into a coal handling and preparation circuit as a medium to provide correct density to volumetric flow. This provides the ability to separate size specific particles by density due to a cyclonic dynamic generated within the separation asset. The cost of this media is high and the recovery of the media is a critical part of classifying ores.

Inefficient media recovery can cost a mine operation significant sums of money. While there is an acceptable loss rate based on tonnes of product coal produced/processed, exceeding this loss rate has adverse financial consequences. Recovery of the media is directly related to the open area of the screen, its cut point (the size of the fraction passing through the screen) and the point of reclamation on a screen deck containing the screens.

In coal handling preparation plant screening applications it is desirable to encourage stratification of product flow passing over the screens. Stratification is influenced by agitation of the product flow using vibratory actions to shuffle particles so that oversize particles track down the upper bed and near size particles are closer to the screening surface of the screens. This provides a greater probability of undersize particles presenting to the screen apertures to increase the likelihood of passing through those apertures. Stratification can be enhanced by advantageously increasing effective open area of the screen but without increasing aperture size. Increased aperture size is undesirable as that would result in larger particles passing through the screening apertures reducing downstream asset performance.

In de-watering applications, an increased open area without increasing aperture size would be advantageous.

Further, in case of high de-watering applications, surface tension builds up on an under surface of the slurry. This can adversely affect operability of the screen in that near size or undersize particles are inhibited from passing through the screening apertures due to the surface tension.

As indicated above, screening efficiency is dependent on the percentage of open area of the screen. Pegging and blinding of screen apertures by near size particles effectively reduces the open area of the screen which negatively affects screen performance. Pegging occurs where near size particles wedge within the screen aperture and blinding is the result of larger than nominal particles wedging into the aperture causing flexing and distortion of the aperture. This reduces the effective open area by closing/distorting neighbouring apertures.

Another major cost in mining operations, in particular, is the cost of the screens themselves. Once the change out cut point of the screen has been reached, that screen needs to be replaced. While the screens can be recycled, cost of replacement is still a significant operating cost of the mine. Extending the wear life of the screens without adversely impacting screening efficiency could result in significant cost savings for the mining operation.

Related to this is that maintaining the nominal cut point deeper into the life of the screen ensures that there is greater particle size control which advantageously influences downstream operations of the ore dressing process.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In a first aspect, there is provided a screen which includes

a support structure; and

a plurality of screening elements arranged in spaced relationship on the support structure to define screening apertures between adjacent screening elements, each screening element defining a screening surface and the screening surface of each of at least some of the screening elements being spaced further from the support structure than the screening surface of each of the remaining screening elements so that, on opposed sides of each screening aperture associated with the at least some of the screening elements, the screening surfaces are at different heights, each screening element having a screening portion and a root portion, the screening portion of each of the at least some of the screening elements differing in width from the screening portion of each of the remaining screening elements.

For the avoidance of doubt, the term “remaining screening elements” refers to all the screening elements other than the “at least some of the screening elements”.

The screening surface of each alternate screening element may be spaced further from the support structure than its neighbouring screening element, each alternate screening element being referred to as a superior screening element and each neighbouring screening element being referred to as an inferior screening element. By “alternate” is meant every second one of the series of screening elements.

The screening elements may be elongate screening elements extending transversely to the support structure, the screening elements being arranged at spaced intervals relative to one another to define slot-like screening apertures between adjacent screening elements. Each screening element may be in the form of shaped wire and in which the root portions of both the superior screening elements and the inferior screening elements having the same profile.

Prior to use, the screening apertures between adjacent superior and inferior screening elements may have a predetermined width, and a shape of the screening portion of each of the superior screening elements may be such that, as the screening surface of the screening portion of each superior screening element wears down, in use, the screening aperture retains substantially that predetermined width up to, and including, when the screening surface of the screening portion of each superior screening element is worn down to a level to lie substantially planar with the screening surface of the screening portion of each neighbouring inferior screening element.

The support structure may comprise a plurality of spaced, parallel bars to which the screening elements are attached. More particularly, the screening elements may be attached to the bars of the support structure by welding. By having the root profiles of the superior screening elements and the inferior screening elements the same, the same welding current can be used on both types of screening elements at a predetermined frequency.

In a second aspect, there is provided a screen deck which includes

a framework; and

a plurality of screens, as described above, mounted on the framework.

In a third aspect, there is provided a water well screening assembly which includes

a casing; and

a screen, as described above, formed into a cylindrical form and arranged distally of the casing.

### BRIEF DESCRIPTION OF DRAWINGS

Embodiments of the disclosure are now described by way of example with reference to the accompanying drawings in which:—

FIG. 1 shows a perspective view of an embodiment of a screen;

FIG. 2 shows a sectional end view of a part of a first embodiment of a screen;

FIG. 3 shows, on an enlarged scale, a part of the screen of FIG. 2 circled by Circle ‘A’;

FIG. 4 shows a sectional end view of a part of a second embodiment of a screen;

FIG. 5 shows, on an enlarged scale, a part of the screen of FIG. 4 circled by Circle ‘B’;

FIG. 6 shows a sectional end view of a part of a third embodiment of a screen;

FIG. 7 shows, on an enlarged scale, a part of the screen of FIG. 6 circled by Circle ‘C’;

FIG. 8 shows a sectional end view of a part of a fourth embodiment of a screen;

FIG. 9 shows, on an enlarged scale, a part of the screen of FIG. 8 circled by Circle ‘D’;

FIG. 10 shows a sectional end view of a part of a fifth embodiment of a screen;

FIG. 11 shows, on an enlarged scale, a part of the screen of FIG. 10 circled by Circle ‘E’;

FIG. 12 shows a perspective view of a screen deck incorporating a plurality of the screens of one or more of FIG. 1, 2, 4, 6, 8 or 10;

FIG. 13 shows a schematic representation of a media recovery screening application incorporating embodiments of the screens of one or more of FIG. 1, 2, 4, 6, 8 or 10;

FIG. 14 shows a schematic representation of a classification screening application incorporating embodiments of the screens of one or more of FIG. 1, 2, 4, 6, 8 or 10;

FIG. 15 shows a schematic representation of a de-watering screening application incorporating embodiments of the screens of one or more of FIG. 1, 2, 4, 6, 8 or 10;

FIG. 16 shows a perspective, partially cutaway view of another embodiment of a screen; and

FIG. 17 shows a schematic representation of the application of the screen of FIG. 16.

### DETAILED DESCRIPTION OF EXEMPLARY EMBODIMENTS

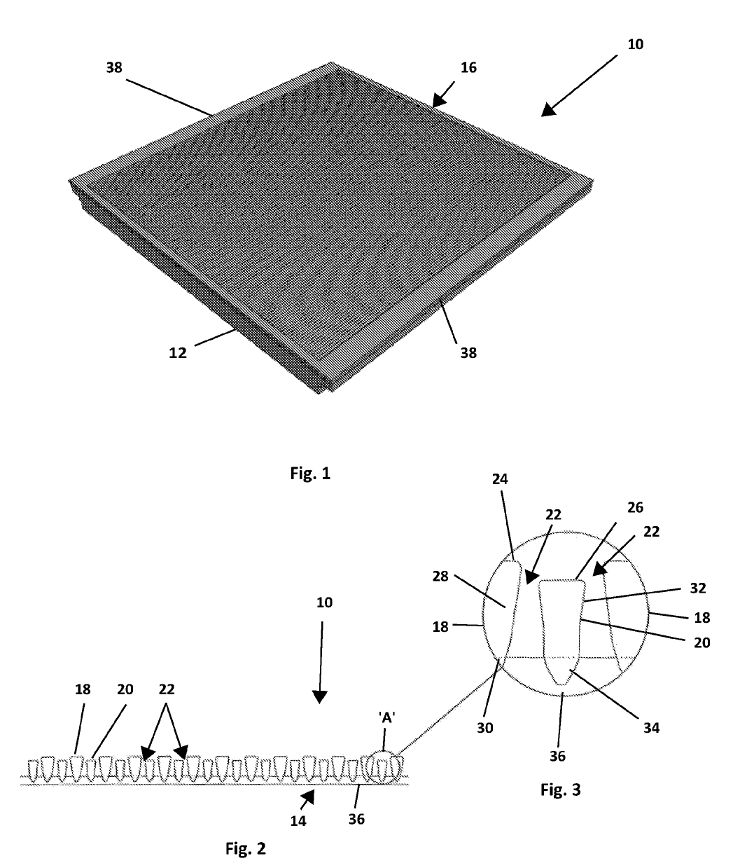

Referring initially to FIG. 1 of the drawings, reference numeral 10 generally designates an embodiment of a screen in the form of a screening panel. The screening panel 10 comprises a frame 12 bounding a support structure 14 (FIGS. 2-11). The screening panel 10 defines a screening surface 16 defined by a plurality of discrete screening elements 18, 20.

In the embodiments of FIGS. 1-11 of the drawings, the screening elements 18, 20 are elongate screening elements, as will be described in greater detail below to define a slot-like screening aperture 22 between each adjacent pair of screening elements 18 and 20. It will, however, be appreciated that, in other embodiments, the screening elements 18, 20 may adopt other configurations, for example, cuboid or other polygonal shapes to define different shapes of screening apertures for different applications.

The screening elements 18, 20 are arranged in spaced relationship on the support structure 14 to define the slot-like screening apertures 22 which are spaced from each other. Each screening element 18 defines a screening surface 24 (see, for example, FIG. 3 of the drawings) and, similarly, each screening element 20 defines a screening surface 26. The screening elements 18, 20 are configured so that the screening surfaces 24 of the screening elements 18 are spaced further from the support structure 14 than the screening surfaces 26 of the screening elements 20.

In other words, the screening surfaces 24 stand proud relative to the support structure more than the screening surfaces 26 so that, on opposed sides of each screening aperture 22, the screening surfaces 24 and 26 are at different heights. As a result, the screening apertures 22 are arranged at an acute angle relative to a plane in which each of the screening surfaces 24 or 26, as the case may be, lie. Due to this arrangement, a greater number of screening apertures 22 are able to be defined in the screening panel 10 resulting in an increased open area of the panel 10, as will be described in greater detail below, in comparison with screening panels where the screening surfaces of adjacent screening elements lie in the same plane.

For ease of explanation, due to the configuration of the screening elements 18 and 20 on the support structure 14, the screening elements 18 are referred to as the superior screening elements and the screening elements 20 are referred to as the inferior screening elements.

Each superior screening element 18 is in the form a shaped wire having a screening, or head, portion, 28 defining the screening surface 24 and a root portion 30 integrally formed with the head portion 28. Similarly, each inferior screening element 20 is also in the form of a shaped wire having a screening, or head, portion, 32 and a root portion 34 integrally formed with the head portion 32.

The root portions 30 of the superior screening elements 18 are of the same shape and configuration as the root portions 34 of the inferior screening elements 20. In other words, the root portions 30 and 34 have substantially the same profile.

The support structure 14 of the screening panel 10 comprises a plurality of spaced, parallel bars 36 extending between opposed sides 38 (FIG. 1) of the frame 12 of the screening panel 10. The superior screening elements 18 and inferior screening elements 20 are secured to the bars 36 by welding. Due to the fact that the root profiles 30 and 34 are substantially the same, the frequency of the welding current applied to weld the screening elements 18 and 20 to the bars 36 is the same. Thus, the same welding frequency can be used to secure both the superior screening elements 18 and the inferior screening elements 20 to the support structure 14.

The screening panel 10 has a steel frame 12 coated with a suitable plastics material, such as a polyethylene plastics. The screening elements 18 and 20 are suitable steel elements, for example, of 304 stainless steel. It will be appreciated that other suitable grades of stainless steel or other steel or plastics materials could be used in appropriate circumstances.

In general, the screening panel 10 is substantially square when viewed in plan having a screening area of approximately 610 mm×610 mm. Typically, each screening aperture 22 between adjacent screening elements 18, 20 defines a gap, or slot size, of the order of 1 mm. Having the superior screening elements 18 higher than those of the inferior screening elements 20 results in a number of benefits including, depending on the profiles of the screening elements 18 and 20, an increased so-called “open area”, an increased classification life and an increased wear life. Increasing the “open area” of the screening area of the screening panel 10 results in improved efficiencies in various screening operations. Increasing the classification life of the screening panel 10 results in a greater period of time for achieving a desired classification efficiency. Increasing the wear life results in the screening panel 10 being able to be used for a longer period of time before needing to be replaced.

By having the superior screening elements 18 standing proud relative to the support structure 14 by a greater amount than that of the inferior screening elements 20, the open area of the screening panel 10 is increased by between about 3% and 50%, in comparison with a conventional screening panel, depending on the selected profiles of the superior screening elements 18 and the inferior screening elements 20 and the profiles of the conventional screening panel. More particularly, the open area of the screening panel is increased by between about 6% and 25%. The increase in open area may be between any of the ranges of 3% to 5%, 5% to 10%, 10% to 15%, 15% to 20%, 20% to 25%, 25% to 30%, 30% to 35%, 35% to 40%, 40% to 45% and 45% to 50%.

The head portion 28 of each superior screening element 18 is shaped such that, as the screening surface 24 of each superior screening element 18 wears down, in use, the screening aperture 22 between the superior screening element 24 and the adjacent inferior screening element 26 retains substantially the same slot size up to, and including, when the screening surface 24 of each superior screening element 18 become substantially co-planar with the screening surface 26 of the adjacent inferior screening element 20.

Classification efficiency is governed by the ratio of near size and undersize particles to oversize particles passing through the screening apertures 22 of the screening panel 10. Increasing the period of time for which the screening panel 10 operates within specification, i.e. at the desired classification efficiency, results in greater cost savings for an operator.

Once again, by having the superior screening elements 18 and the inferior screening elements 20 of different heights, the classification life of the screening panels 10 is considerably improved over the conventional screening panels. In particular, this occurs due to the superior screening element 18 having increased material in its head portion 28 with the superior screening element 18 also serving, at least to an extent, to shield the inferior screening element 20 against wear.

Screening panels 10 in accordance with the present disclosure have an improvement in classification life of anything from about 150% to 400% in comparison with the classification life of a conventional screening panel. More particularly, screening panels 10 may have an improved classification life of between about 155% to about 380%. Typically, the improvement in classification life lies in the ranges from about 150% to 200%, 200% to 250%, 250% to 300%, 300% to 350% and 350% to 400%.

In addition, screening panels are operated until the screening panel reaches a cut point where the size of fraction passing through the screening apertures exceeds a permissible size. This results in what is known as “change out” when the screening panel is out of specification and needs to be replaced. For an installed screening panel aperture of approximately 1 mm, typically the change out cut point occurs when the aperture becomes approximately 1.4 mm.

Due to the configuration of the head portion 28 of each superior screening element 18, the operating parameters of the screening panel 10 remain within specification for a greater period of time resulting in an increased wear life before reaching “change out”.

Once again, depending on the shape and configuration of the superior screening elements 18 and the inferior screening elements 20, wear life is increased from between about 30% to about 60% and, more particularly, anywhere from about 38% to about 60%. Typically, the increase in wear life falls within ranges from about 30% to 35%, 35% to 40%, 40% to 45%, 45% to 50%, 50% to 55% and 55% to 60%.

The panel 10 shown in FIGS. 2 and 3 of the drawings has a superior screening element 18 with a screening surface 24 having a width of approximately 3.3 mm and an inferior screening element 20 with a screening surface 26 having a width of approximately 2.34 mm. The height difference between the screening surfaces 24 and 26 is approximately 0.99 mm and the screening aperture 22 between adjacent screening elements 18 and 20 has a slot size about 1 mm.

A similar, conventional panel with screening surfaces of all its screening elements of 3.3 mm, and all the screening elements having their screening surfaces at the same height as one another and a screening aperture (slot) of approximately 1 mm gives an open area of approximately 23%.

Comparing the screening panel 10 of FIGS. 2 and 3 with such a conventional screening panel, the screening panel 10 of FIGS. 2 and 3 has an open area of approximately 26% providing an increased open area of approximately 13% in comparison with the conventional screening panel. This results in improved media recovery and de-watering performance of the screening panel 10 of FIGS. 2 and 3 in comparison with the conventional screening panel.

In addition, in the case of the conventional screening panel, there is approximately 1.84 mm of wear before change out is required at approximately 1.4 mm aperture width. In the case of the screening panel 10 of FIGS. 2 and 3, there is approximately 2.72 mm of wear. As a result, there is approximately 0.88 mm additional wear before change out of the screening panel 10 in comparison with the conventional screening panel giving a 48% increase in total wear life in comparison with the conventional screening panel.

Still further, with the conventional screening panel, there is approximately 0.38 mm of wear before aperture increase. The staggered arrangement of the superior screening elements 18 and inferior screening elements 20 results in an approximately 0.69 mm of wear before aperture increase resulting in an approximately 182% increase in classification efficiency in comparison with the referenced, conventional screening panel.

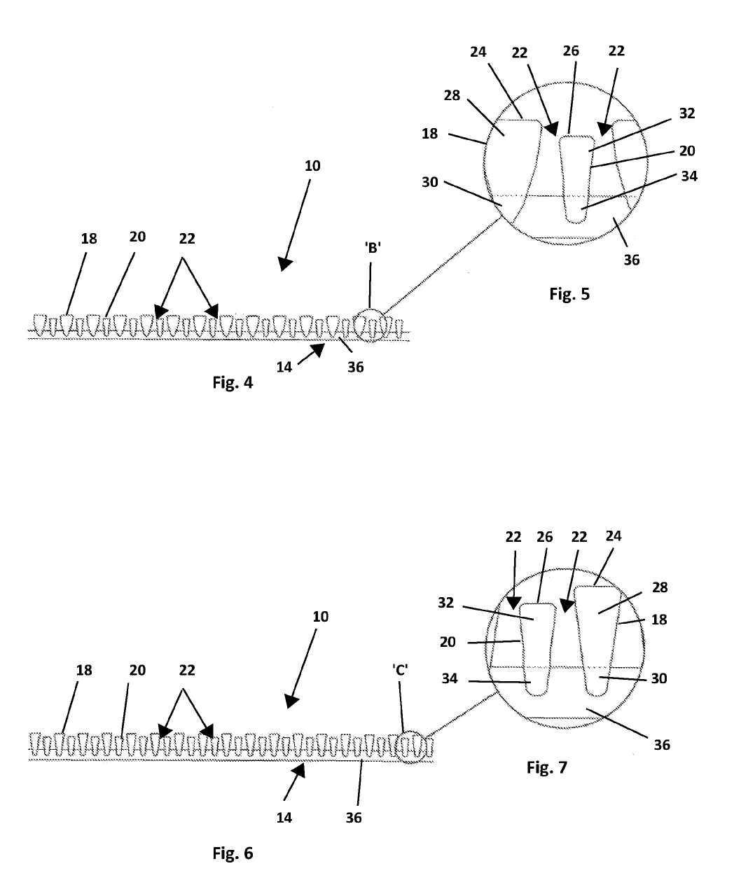

Referring to FIGS. 4 and 5 of the drawings, like reference numerals refer to like parts, unless otherwise specified. Once again, this panel 10 is compared with the conventional screening panel referenced in paragraph [0059] above.

In the case of the panel illustrated in FIGS. 4 and 5 of the drawings, once again, the screening surface 24 of the superior screening element 18 has a width of approximately 3.3 mm. However, the screening surface 26 of the inferior screening element 20 has a width of approximately 1.8 mm and there is a height difference between the screening surfaces 24 and 26 of approximately 0.85 mm. Once again, the screening aperture 22 between adjacent screening elements 18 and 20 has slot size of approximately 1 mm.

As described above, the conventional screening panel has an open area of approximately 23%. With the configuration of the superior screening elements 18 and inferior screening elements 20 of the screening panel 10 of FIGS. 4 and 5, the screening panel 10 has an open area of approximately 28% providing an increase in open area of approximately 21%.

In addition, in the case of the conventional screening panel, there is approximately 1.83 mm of wear before change out is required at approximately 1.4 mm aperture width. In the case of the screening panel 10 of FIGS. 4 and 5, there is approximately 2.52 mm of wear. As a result, there is approximately 0.69 mm additional wear before change out of the screening panel 10 in comparison with the conventional screening panel giving an approximately 38% increase in total wear life in comparison with the conventional screening panel.

Still further, with the conventional screening panel, there is approximately 0.38 mm of wear before aperture increase. The staggered arrangement of the superior screening elements 18 and inferior screening elements 20 results in an approximately 0.97 mm of wear before aperture increase resulting in an approximately 155% increase in classification efficiency in comparison with the referenced, conventional screening panel.

In FIGS. 6 and 7 of the drawings, a further embodiment of a screening panel is illustrated and is designated generally by the reference numeral 10. As in the case of the preceding embodiments, like reference numerals refer to like parts, unless otherwise specified.

This embodiment of screening panel is compared with a conventional screening panel having screening wires with screening surfaces co-planar with respect to each other and with the screening surface of each screening wire having a width of approximately 2.34 mm. For a screening aperture with a slot size of approximately 1 mm, this provides a panel with an open area of approximately 30%.

In the case of the screening panel 10 of FIGS. 6 and 7, the screening surface 24 of each superior screening element 18 has a width of approximately 2.34 mm and the screening surface 26 of each inferior screening element 20 has a width of approximately 1.8 mm. The height difference between the screening surface 24 of the superior screening element 18 and the screening surface 26 of the inferior screening element 20 is approximately 0.86 mm. The screening aperture 22 between adjacent screening elements 18 and 20 has a slot size of approximately 1 mm.

This configuration of superior screening elements 18 and inferior screening elements 20 results in an open area per panel 10 of approximately 33% providing a 9% open area increase over the conventional screening panel referenced in paragraph [(0069] above.

The conventional screening panel has approximately 0.25 mm of wear before any aperture increase whereas the screening panel 10 of the embodiment of FIGS. 6 and 7 of the drawings has approximately 0.98 mm of wear before any aperture increase. This therefore provides an additional approximately 0.73 mm penetrative wear prior to any influence on the screening apertures 22 giving an approximately 292% increase in classification efficiency.

Further, the conventional screening panel referenced in paragraph [0069] has approximately 1.69 mm of wear before change out at approximately 1.4 mm aperture size. The screening panel 10 of this embodiment has approximately 2.64 mm of wear before change out at 1.4 mm aperture size is required. This additional approximately 0.95 mm wear before change out gives an approximately 56% increase in total wear life in comparison with the referenced, conventional screening panel.

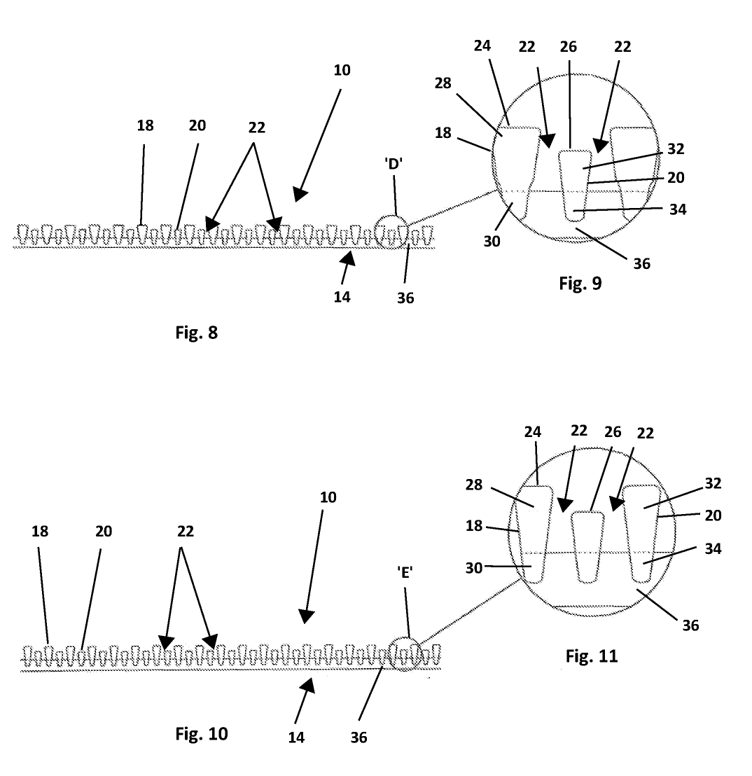

In FIGS. 8 and 9 of the drawings, yet a further embodiment of a screening panel 10 is illustrated. As with the case of the previous embodiments, like reference numerals refer to like parts, unless otherwise specified. In this embodiment, the screening panel 10 is, once again, compared with the conventional screening panel described in paragraph [0069] above.

As in the preceding embodiment, the screening surface 24 of each superior screening element 18 has a width of approximately 2.34 mm. The screening surface 26 of each inferior screening element 20 has a width of approximately 1.52 mm. The height difference between the screening surface 24 and the adjacent screening surface 26 is approximately 1.07 mm.

This configuration of screening elements 18 and 20 provides an open area of approximately 34% giving an approximate 14% open area increase over the approximately 30% open area of the referenced, conventional screening panel.

In this embodiment, the screening panel 10 has approximately 1.13 mm of wear before aperture increase. This additional approximate 0.88 mm penetrative wear prior to any influence on the screening apertures 22, in comparison with the conventional screening panel, provides a further increase in classification efficiency of approximately 353%.

Further, in this embodiment, there is approximately 2.56 mm of wear before change out is required at 1.4 mm aperture size. This additional approximate 0.87 mm wear before change out gives an approximate 51% increase in total wear life.

Referring now to FIGS. 10 and 11 of the drawings still a further embodiment of a screening panel 10 is illustrated. As with the embodiments of FIGS. 2 to 9 of the drawings, like reference numerals refer to like parts, unless otherwise specified,

In this embodiment, the screening panel 10 is compared with a conventional screening panel having screening elements all arranged at the same height with a width of each screening element being approximately 1.8 mm and a screening aperture of approximately 1 mm. Such a screening panel has an open area of approximately 36%.

The screening surface 24 of each superior screening element 18 has a width of approximately 1.8 mm. The screening surface 26 of each inferior screening element 20 has a width of approximately 1.52 mm. The height difference between the screening surface 24 and the adjacent screening surface 26 is approximately 1.21 mm and the screening aperture 22 between adjacent screening elements 18 and 20 is about 1 mm.

This configuration of screening elements 18 and 20 provides an open area of approximately 38% resulting in an open area increase of approximately 5.5% over the referenced, conventional screening panel referred to in paragraph [0080].

The conventional screening panel described in paragraph [0080] has approximately 0.3 mm of wear before aperture increase. The embodiment of screening panel 10 of FIGS. 10 and 11 has approximately 1.3 mm of wear before aperture increase. This additional 1 mm of wear provides an approximately 332% increase in classification efficiency.

Further, the conventional screening panel referenced in paragraph [0080] has approximately 1.95 mm of wear before change out at 1.4 mm aperture size. The screening panel 10 of this embodiment has approximately 3.04 mm of wear before change out is required. This additional approximate 1.09 mm of wear before change out gives an approximately 56% increase in total wear life.

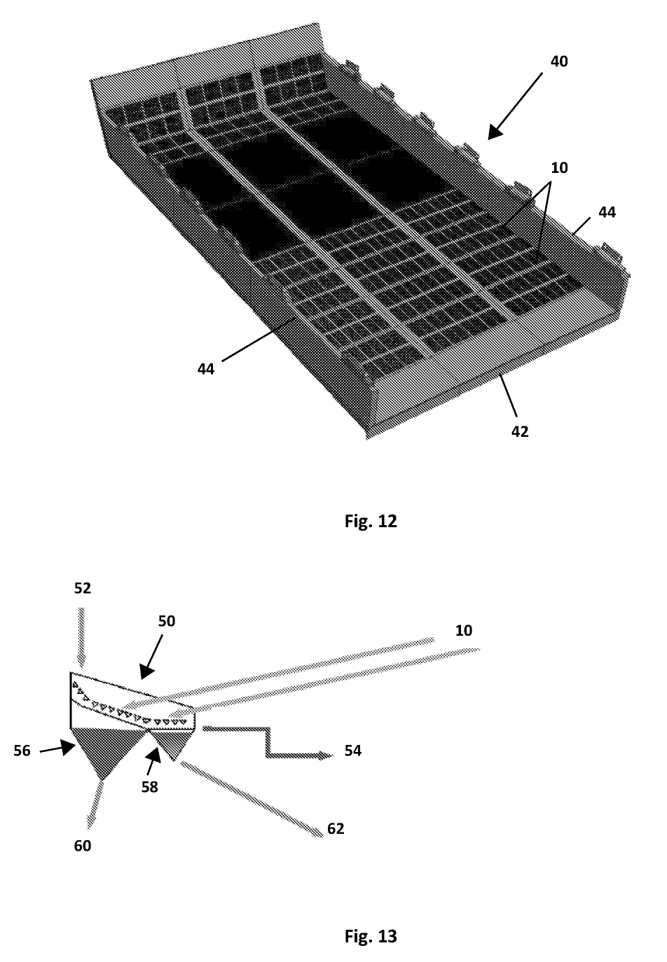

In FIG. 12 of the drawings reference numerals 40 generally designates a screen deck including a plurality of screening panels 10 in accordance with one or more of the embodiments described above. The screen deck 40 includes a framework 42 on which a plurality of screening panels 10, in accordance with one or more of the embodiments described above, are mounted. The framework 42 of the screen deck 40 includes side beams 44 which are used to retain the screening panels 10 on the framework 42. The screen deck 10 is a vibratory deck 40 using a reciprocating, vibratory motion to the panels 10 to effect screening of product passing over the screening panels 10.

As described below with reference to FIGS. 13-15 of the drawings, screen decks 40 employing embodiments of the screening panels 10 are used in various applications including media recovery, classification and de-watering.

In FIG. 13 of the drawings, reference numeral 50 generally designates a multi-slope drain and rinse screen deck used for media recovery. A slurry is introduced to the deck 50 at 52. Screening panels 10, in accordance with one or more of the embodiments described above, are mounted on the deck 50, as illustrated. Overflow product is discharged from the deck 50 at 54, the overflow product either containing product for further processing, for example, in a coarse coal centrifuge, or reject material for disposal. The screen deck 50 includes two discharge zones 56 and 58. The discharge zone 56 is a drain section through which correct media is discharged at 60. The zone 58 is a rinse section through which dilute media is discharged at 62.

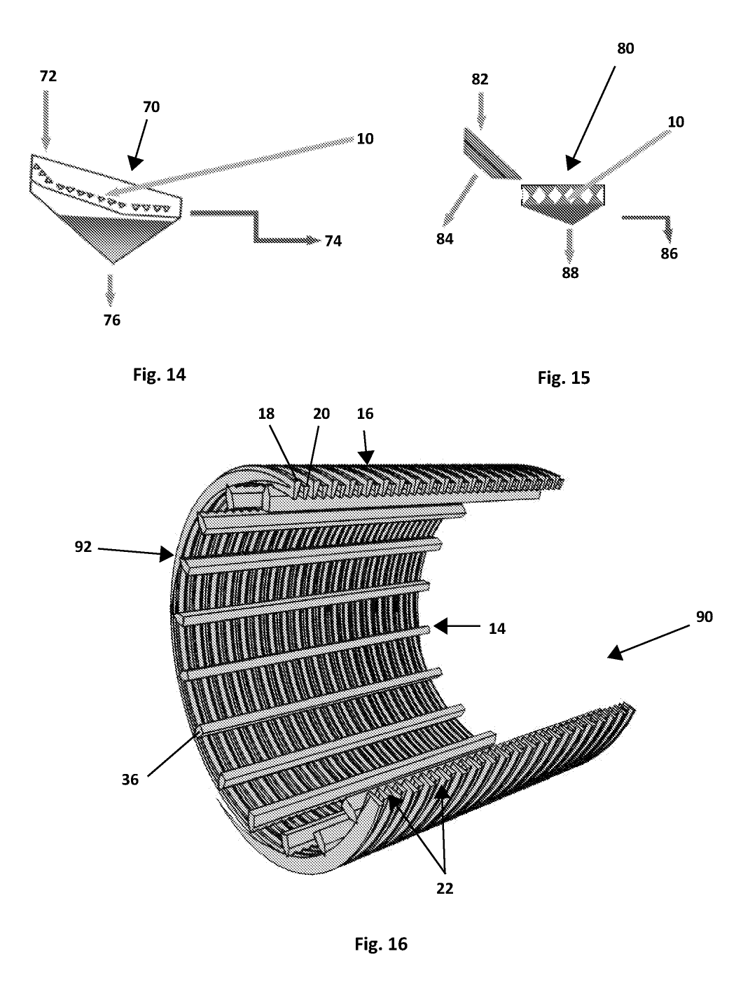

In FIG. 14 of the drawings, reference numeral 70 generally designates a multi-slope de-slime screen deck used for classification. A slurry is introduced to the deck 70 at 72. Screening panels 10, in accordance with one or more embodiments described above, are mounted on the deck 70, as illustrated. Overflow product at >2000 μm is discharged from the deck 70 and 74 and under flow product at <2000 μm is discharged at 76.

Referring to FIG. 15 of the drawings, reference numeral 80 generally designates a low overhead screen and sieve bend deck used in de-watering applications. A slurry to be de-watered is fed on to the deck 80 via a screen feed 82 having an underflow discharge 84. Screening panels 10, in accordance with one or more of the embodiments described above, are mounted on the deck 80, as illustrated. Overflow product, be it product for further processing or reject product, is discharged at 86. Moisture extracted from the slurry is discharged at 88.

FIG. 16 shows a further embodiment of a screen 90. With reference to FIGS. 1-11 of the drawings, like reference numerals refer to like parts, unless otherwise specified.

In this embodiment, the screen 90 is in the form of a right circular cylinder 92, with the screening surface 16 being an outer surface of the cylinder 92. The structure of the cylinder 92 is similar to that of the screening panel 10 of FIGS. 1-11 of the drawings. Thus, the cylinder 92 includes the support structure 14 comprising a plurality of spaced, parallel bars 36 extending parallel to a longitudinal axis of the cylinder 92.

The bars 36 of the support structure 14 support a plurality of longitudinally spaced, circumferentially extending superior screening elements 18 alternating with inferior screening elements 20, neighbouring screening elements 18 and 20 defining the screening apertures 22 between them.

The screen 90 of this embodiment is used either as a water well screen for screening water but can also be used as a trommel screen for screening particulate material to classify that material. The provision of alternating superior screening elements 18 and inferior screening elements 20 provide the same advantages as those for the screening panel 10, in particular, better well efficiency in water well applications. In addition, because of the increased open area in comparison with other screens, the screen 90 provides lower pumping costs, less pump wear, longer well life, easier rehabilitation and more efficient sampling.

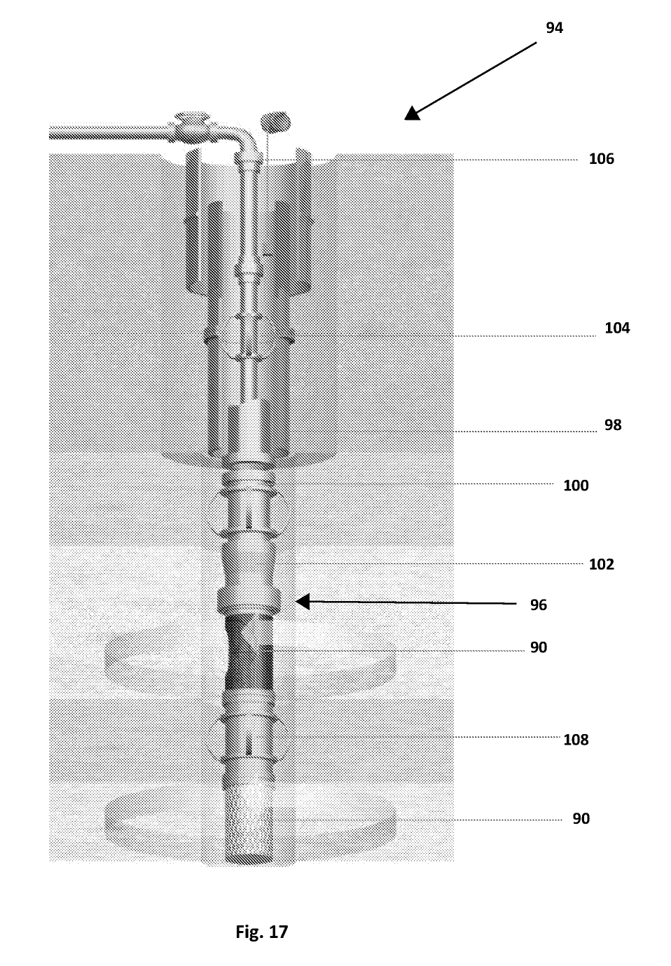

An embodiment of the screen 90 is shown in use in FIG. 17 of the drawings in a water well assembly 94. The water well assembly 94 is inserted into a borehole 96. The water well assembly includes a casing 98 from which an extension pipe 100 depends into the borehole 96.

One or more screens 90 are arranged in the extension pipe 100. The screen 901 substantially centrally located in the extension pipe 100 is a continuous slot screen configured as described above. In the illustrated embodiment, the screen 90 at a distal end of the extension pipe 100 is a bridge-slot screen which may, or may not, be configured as described above.

A di-electric coupling 102 is arranged in the extension pipe 100. A riser pipe 104 extends from the extension pipe through the casing 98 to extend out of the borehole 96. Hydrometry instruments 106 are mounted in the riser pipe 104. The assembly 94 includes centralisers 108 centering the assembly 94 in the borehole 96 as well as centering the riser pipe 104 in the casing 98.

It is an advantage of the described embodiments that a screening panel 10 is provided which, due to its increased open area per unit panel size, results in increased media recovery while reducing media losses. This results in increased cost savings in mining operations.

It is a further advantage of the described embodiments that a screening panel 10 is provided which results in improved stratification by increasing percentage open area without increasing aperture size and particle size reporting downstream. This is achieved by maintaining the nominal cut point of the screening panel 10 deeper into the life-cycle of the panel 10 as a result of the difference in height between the superior screening elements 18 and the inferior screening elements 20. The superior screening elements 18 further function to protect the inferior screening elements 20 from excessive abrasive wear from large material particles on the screening surface 16 of the screening panel 10, 90.

The profiles of the superior screening elements 18 are selected based on the wearability of the superior screening elements 18 and the performance value of the profiles of the inferior screening elements 20. Reducing the wear rate of the screening elements 18 and 20 provides greater control in particle size passing/reporting to downstream correct media, dilute media and spiral circuits. This results in a greater screening efficiency and performance without overloading downstream on-flow/process-flow components with higher concentrations of oversized material in mining operations.

Yet a further advantage of the described embodiments is that a screening panel 10 is provided which, due to its higher open area without particle compromise, increases de-watering percentage capacity relative to the open area percentage increase.

Still further, the difference in height between the superior screening elements 18 and the inferior screening elements 20 of the described embodiments of the screening panel 10 results in breaking of surface tension in the slurry deposited on the screening panels 10 resulting in improved de-watering capabilities of the screening panels 10.

The difference in height between the superior screening elements 18 and the inferior screening elements 20 reduces the likelihood of pegging and or blinding of the screening apertures 22 of the screening panels 10. This is achieved as a result of the angled screening apertures 22 due to the height differential between the adjacent screening elements 18 and 20. With this configuration, larger particles are likely to be suspended between two neighbouring superior screening elements 18 allowing near size or undersize particles to pass beneath the suspended larger particle. The larger particle is then able to “roll out” off the panel 10.

Yet a further advantage of the described embodiments of the screening panel 10 is that, by appropriate selection of the profiles of the superior screening elements 18 and the inferior screening elements 20, screening elements 18 and 20 can be engineered to suit various operational conditions. In particular, due to the height differential between the superior screening elements 18 and the adjacent inferior screening elements 20, the superior screening elements 18 can be selected for durability to provide protection to the secondary screening elements 20. The profile of the secondary screening elements 20 is selected based on performance value. This does not compromise integrity of the screening panel 10 but improves screen wear resistance whilst maintaining the nominal cut point deeper into the extended screening panel life.

A related advantage is that maintaining the nominal cut point deeper into the extended panel life ensures greater particle size controlled reporting to various downstream circuits which, in turn, enhances screen performance whilst positively influencing upstream and downstream components of the ore dressing circuit.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A screen which includes
a support structure; and
a plurality of screening elements arranged in spaced relationship on the support structure to define screening apertures between adjacent screening elements, each screening element defining a screening surface and the screening surface of each of at least some of the screening elements being spaced further from the support structure than the screening surface of each of the remaining screening elements so that, on opposed sides of each screening aperture associated with the at least some of the screening elements, the screening surfaces are at different heights, each screening element having a screening portion and a root portion, the screening portion of each of the at least some of the screening elements differing in width from the screening portion of each of the remaining screening elements.

2. The screen of claim 1 in which the screening surface of each alternate screening element (a “superior screening element”) is spaced further from the support structure than its neighbouring screening element (an “inferior screening element”).

3. The screen of claim 2 in which the screening elements are elongate screening elements extending transversely to the support structure, the screening elements being arranged at spaced intervals relative to one another to define slot-like screening apertures between adjacent screening elements.

4. The screen of claim 3 in which each screening element is in the form of shaped wire, and in which the root portions of both the superior screening elements and the inferior screening elements having substantially the same profile.

5. The screen of claim 4 in which, prior to use, the screening apertures between adjacent superior and inferior screening elements has a predetermined width, and a shape of the screening portion of each of the superior screening elements is such that, as the screening surface of the screening portion of each superior screening element wears down, in use, the screening aperture retains substantially that predetermined width up to, and including, when the screening surface of the screening portion of each superior screening element is worn down to a level to lie substantially planar with the screening surface of the screening portion of each neighbouring inferior screening element.

6. The screen of claim 1 in which the support structure comprises a plurality of spaced, parallel bars to which the screening elements are attached.

7. The screen of claim 6 in which the screening elements are attached to the bars of the support structure by welding.

8. A screen deck which includes
a framework; and
a plurality of screens, as claimed in claim 1, mounted on the framework.

9. A water well screening assembly which includes
a casing; and
a screen, as claimed in claim 1, formed into a cylindrical form and arranged distally of the casing.
